(19) United States
(12) Patent Application Publication
(10) Pub. No.: US 2006/0080334 A1
(43) Pub. Date: Apr. 13, 2006

(54) Method for configuration file management in a computing system

(75) Inventors: Guang-Jian Wang, Shenzhen (CN); Hong-Tao Ma, Shenzhen (CN); Yu-Long Lin, Shenzhen (CN); Dong-Feng Wang, Shenzhen (CN); Juan Wu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/081,956

(22) Filed: Mar. 16, 2005

(30) Foreign Application Priority Data
Sep. 24, 2004 (TW) 93128985

(51) Int. Cl. G06F 7/00

(52) U.S. Cl. 707/100

(57) ABSTRACT

A method for configuration file management in a computing system includes the steps of: acquiring a name and a type of hardware, and selecting a particular installation interface for the hardware according to the type of hardware; establishing configuration files, processing a plurality of parameter expressions in a configuration file, storing the processed parameter expressions as configuration information, and configuring program; accessing the configuration files, and comparing the configuration files to parameter of running hardware; determining whether the configuration files and parameter of running hardware match; executing the programs using the stored configuration information if the configuration files and parameter of running hardware match; determining whether the programs are operable; and appending the programs to the compact disc if the programs are operable.

### BACKGROUND OF THE INVENTION

1. Field of the Invention

The present invention generally relates to the field of computing systems management, and more particularly to configuration file management in computing systems.

2. Prior Art

A typical computing system executes software programs to perform processing tasks. Programs may access hard-coded parameters to perform these tasks, or may generate parameters during execution. Some computing systems maintain parameters separate from or external to the program, and provide access to these parameters for program execution. For example, computing systems running in an MS-WINDOWS environment may support control or configuration files that store parameters for access by programs during execution.

As computing systems become larger and more complex, configuration files and their contents become more numerous and difficult to manage and organize. A typical computing system may include tens or hundreds of configuration files scattered throughout the system with little or no overall organization. Furthermore, computing systems that run different programs may have configuration files for one program that duplicate or conflict with configuration files for another program. Therefore, a need exists for effective configuration file management in computing systems.

### SUMMARY OF THE INVENTION

Accordingly, a general object of the present invention is to provide a method for effective configuration file management in a computing system.

To accomplish the above objective, the present invention provides a method for configuration file management in a computing system. The method comprises the steps of: acquiring a name and a type of hardware in the system, and selecting a particular installation interface for the hardware according to the type of hardware; establishing configuration files, processing a pieces of parameter expressions in each configuration file, storing the processed parameter expressions as configuration information, and configuring program; accessing the configuration files, and comparing the configuration files to parameter of running hardware; determining whether the configuration files and parameter of running hardware is match; executing the programs using the stored configuration information if the configuration files and parameter of running hardware is match; determining whether said programs are operable; and appending the programs to the compact disc if said programs are operable.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of configuration of a compact disc in accordance with a preferred embodiment of the present invention; and

FIG. 2 is a flowchart of a preferred method for configuration file management in a computing system in accordance with the present invention.

### DETAILED DESCRIPTION OF THE INVENTION

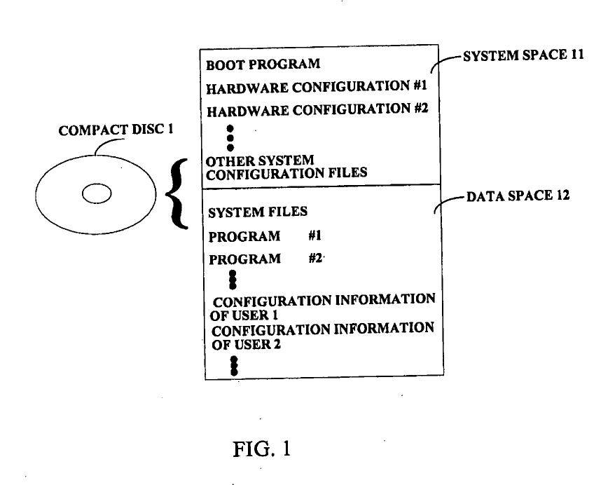

FIG. 1 is a schematic diagram of a configuration of a compact disc in accordance with the preferred embodiment of the present invention. The compact disc 1 comprises a system space 11, and a data space 12. The system space 11 records a boot program, hardware configurations, and other system configuration files. The boot program can control the compact disc 1. The boot program can also make a device load programs from the compact disc 1. The hardware configurations include information such as a type of a main board, a version number of the main board, a name of the main board, and so on. The other system configuration files contain parameter expressions that specify configuration information. In general, configuration information may include file names, program settings, storage or processing specifications, run time specific information, record information, control information, and/or any other needed information. One of the parameter expressions specifies a value of a parameter. The data space 12 records system files, object programs, and each user's configuration information. The system files relate to text formatting and text content. The programs are a plurality of executable programs operable in the compact disc 1 to perform processing tasks. The programs are also operable to access configuration information for program execution. Each user's configuration information is unique to that particular user. Different users have different configuration requirements, and thus have different configuration information.

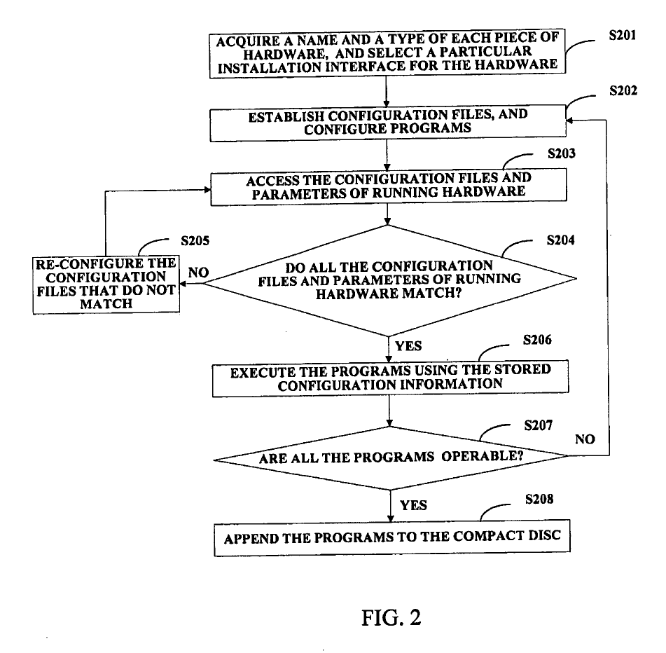

FIG. 2 is a flowchart of a preferred method for configuration file management in a computing system in accordance with the present invention. In step S201, the computing system acquires information, like a name and a type, of each piece of hardware for execution of an object program in the computing system, and selects a particular installation interface for the hardware according to the type of hardware using tools such as DemoShield and InstallShield. In step S202, the computing system establishes configuration files, processes a plurality of parameter expressions in each configuration file, stores the processed parameter expressions as configuration information, and configures programs. In step S203, after configuring the configuration files, the computing system runs the pieces of hardware to obtain parameters of the hardware via a testing program simulating the object program in the computer. The computing system accesses the configuration files, and compares the configuration files to the parameters of the plurality of running hardware. In step S204, the computing system determines whether all the configuration files and the parameters of the running hardware match. If any configuration files and the parameters of the running hardware do not match, in step S205, the computing system re-configures the configuration files that do not match, whereupon the procedure returns to step S203 in respect of the re-configured configuration files. If and when all the configuration files and the parameters of the running hardware match, in step S206, the computing system executes the programs using the stored configuration information. In step S207, the computing system determines whether all the object programs are operable. If any of the object programs are not operable, the procedure returns to step S202 for the computing system to configure the programs again as needed. If and when all the object programs are operable, in step S208, the computing system appends the object programs to the compact disc 1.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A method for configuration file management in a computing system, the method comprising the steps of:
acquiring a name and a type of each of pieces of hardware, and selecting a particular installation interface for the hardware according to a type of the hardware;
establishing configuration files, processing a plurality of parameter expressions in each configuration file, storing the processed parameter expressions as configuration information, and configuring programs;
accessing the configuration files, and comparing the configuration files to parameters of running pieces of hardware;
determining whether the configuration files and parameters of running hardware match;
executing the programs using the stored configuration information if the configuration files and parameters of running hardware match;
determining whether the programs are operable; and
appending the programs to a compact disc if the programs are operable.

2. The method as claimed in claim 1, further comprising the step of:
re-configuring one or more configuration files that do not match the parameters of running hardware.

3. The method as claimed in claim 1, further comprising the step of:
re-configuring one or more programs if any of the programs are not operable.

4. The method as claimed in claim 1, wherein the step of selecting a particular installation interface for the hardware according to a type of the hardware is performed using either or both of the tools DemoShield and InstallShield.

5. A method for managing configuration files in a computing system and creating related compact discs (CDs), comprising the steps of:
retrieving information about predetermined hardware supporting execution of an object executable program;
creating said configuration files based on said information of said hardware;
testing execution of said program by using said predetermined hardware in said computing system;
retrieving related parameters of said predetermined hardware in said computing system in said testing step;
verifying identification of said related parameters and said information of said configuration files;
modifying said configuration files in case that difference of said related parameters and said information of said configuration files is identified in said verifying step; and
appending said modified configuration files and said program to said related CDs.

6. The method as claimed in claim 5, further comprising the step of verifying executability of said program before said appending step.

7. The method as claimed in claim 5, further comprising the step of selecting a particular installation interface of DemoShield and InstallShield to perform subsequent steps after said hardware-information-retrieving step.

8. A method for managing configuration files corresponding to an object executable program in a computing system, comprising the steps of:
acquiring information of hardware supporting execution of said program;
creating said configuration files having parameter expressions related to said hardware based on said information of said hardware;
testing execution of said program by using said supporting hardware in said computing system;
retrieving related parameters of said supporting hardware in said computing system in said testing step; and
verifying said related parameters and said parameter expressions of said configuration files in order to modify said configuration files.
